(19) United States
(12) Patent Application Publication
(10) Pub. No.: US 2002/0150022 A1
(43) Pub. Date: Oct. 17, 2002

(54) Apparatus and method for 3-D storage of information and its retrieval

(76) Inventor: Yurii Alexandrovich Tolmachev, St. Petersburg (RU)

Correspondence Address: William H. Dippert, Cowan, Liebowitz & Latman, P.C., 1133 Avenue of the Americas, New York, NY, 10036, US

(21) Appl. No.: 09/833,548

(22) Filed: Apr. 12, 2001

(51) Int. Cl. G11B 7/00

(52) U.S. Cl. 369/103

(57) ABSTRACT

An apparatus for writing optical information, consisting of a stream of at least one of a plurality of characters, in photosensitive transparent medium, comprising: illuminating means for generating a first light beam for carrying encoded optical patterns and a second light beam for serving as a reference beam; optical encoding means for encoding the first light beam so as to carry optical signal comprising patterns corresponding to said stream of at least one of a plurality of characters and for encoding the second light beam so as to carry a reference optical signal; and directing means for directing said first beam and second beam substantially in counter-propagating directions and focusing them at a predetermined location within the medium so as to form a focal waist within said medium enabling interference between the two beams at a predetermined location within the medium, whereby the first encoded light beam and the second reference beam meet within the medium producing a distinct interference pattern corresponding to said at least one of a plurality of characters and locally changing at least one of the optical characteristics of the medium at that location thus causing distinct inhomogeneities in the medium.

### FIELD OF THE INVENTION

The present invention relates to the storage of information in media and its retrieval, More particularly it relates to apparatus and method for storing information in three-dimensional space of a medium and its retrieval.

### BACKGROUND OF THE INVENTION

There exist many inventions aimed at increasing the information density storage capacity in some volume of matter. See, for example, U.S. Pat. No. 5,761,111 to Glezer, titled METHOD AND APPARATUS PROVIDING 2D/3D OPTICAL INFORMATION STORAGE AND RETRIEVAL IN TRANSPARENT MATERIALS U.S. Pat. No. 5786560 to Tatah et al., titled 3-DIMENSIONAL MICROMACHINING WITH FEMTOSECOND LASER PULSES, and U.S. Pat. No. 5,289,407 to Strickler et al., titled METHOD FOR THREE DIMENSIONAL OPTICAL DATA STORAGE AND RETRIEVAL. See also U.S. Pats. No. 4,041476, 4,466,080 and 4,471,470 all to Swainson et al., all incorporated herein by reference. To achieve greater information density Glezer suggests forming multiple of bubbles of micron and submicron-size in a bulk of transparent material. These bubbles are formed using femtosecond pulse of light by refocusing it from one point of the bulk to another. Glezer claims parallel writing of several points without mentioning that it involves using pulses of substantially great energy levels that are known to be hazardous to optical elements, damaging it irreversibly.

The same sequential writing of the spots by shifting the relative position of the crossing point of the set of crossed beams and the material, the point of crossing being transmitted to and from using some mechanical means, was disclosed by Tatah and Strickler Mechanically, those methods are even more complicated then that of Glezer. It appears that no attention was paid to the problem of concentration of energy needed to produce essential change in the properties of the material. In the analysis of the static configuration of the crossing of the pulses no reference was made or attention given to their propagation in space at the velocity of light, which changes the real dynamics of the system and makes all the system helpless for inscribing at high density Strickler effectively demonstrates the ability of two- (or more) -photons to produce very small optical inhomogeneities in a bulk of transparent matter To create these inhomogeneities, the forward focal plane of a high numerical aperture lens needs to be tuned from one position to another employing mechanical means for that end.

One of results of those works is that the spatial density of information stored in a volume of transparent matter was shown to be 10¹² cm⁻³ A standard CDROM containing 100-micron thick layer filled with bits contains 1.5 10¹² bits at the most. Thus when spending as much as only 1 microsecond to read out a bit of information, 400 hours of permanent work is needed to read out this information.

It is asserted that one can store as much information in a bulk of some transparent matter, as the theory shows. The prospects of such storage are enormous The amount of information will be tremendous as in heavy folio, but to read out the information needed, one must look through thousands of pages, even transparent, containing another data not needed at the moment and masking that needed one. In the reality, there is some optimum between the amount of information and time needed to reach it and read it out.

### BRIEF DESCRIPTION OF THE INVENTION

An objective of the present invention is to provide novel apparatus and method for 3-D storage of information and its retrieval.

Another objective of the present invention is to provide such apparatus and method for 3-D storage of information and its retrieval that increase the writing rate of information and increase the reading rate and reliability of information retrieved at the maximum theoretically possible limit.

Yet another objective of the present invention is to provide apparatus and method for 3-D storage of information and its retrieval allowing great storage density.

The present invention deals with reading and storing information both in digital or analogous form. A main aim of the invention is to provide a solution for the problem of incoherence between great density of the information storage and the low rate of reading it out as was demonstrated in the prior art. The method and apparatus of the present invention are also suitable and effective in increasing the rate of storing information on and reading it from CDs in different multilevel forms.

It is therefore thus provided, in accordance with a preferred embodiment of the present invention, an apparatus for writing optical information, consisting of a stream of at least one of a plurality of characters, in photosensitive transparent medium, comprising:

illuminating means for generating a first light beam for carrying encoded optical patterns and a second light beam for serving as a reference beam;

optical encoding means for encoding the first light beam so as to carry optical signal comprising patterns corresponding to said stream of at least one of a plurality of characters and for encoding the second light beam so

as to carry a reference optical signal; and directing means for directing said first beam and second beam substantially in counter-propagating directions and focusing them at a predetermined location within the medium so as to form a focal waist within said medium enabling interference between the two beams at a predetermined location within the medium,

whereby the first encoded light beam and the second reference beam meet within the medium producing a distinct interference pattern corresponding to said at least one of a plurality of characters and locally changing at least one of the optical characteristics of the medium at that location thus causing distinct inhomogeneities in the medium

Furthermore, in accordance with another preferred embodiment of the present invention, said illuminating means comprises white light source.

Furthermore, in accordance with another preferred embodiment of the present invention, said illuminating means comprises light source selected from a lamp, white-light photodiode, a set of colored photodiodes combined to emit white light or a white laser.

Furthermore, in accordance with another preferred embodiment of the present invention, said illuminating means comprises femtosecond pulse laser.

Furthermore, in accordance with another preferred embodiment of the present invention, said first and second light beams are spatially and time coherent

Furthermore, in accordance with another preferred embodiment of the present invention, said illuminating means produce light whose spectrum is sufficiently broad to create distinctive pikes of an interference pattern in the vicinity of zero-path difference between the two beams.

Furthermore, in accordance with another preferred embodiment of the present invention, the illuminating means comprise a single light source adapted to generate a single light beam and a beam splitter for splitting the beam into a first and a second beam.

Furthermore, in accordance with another preferred embodiment of the present invention, said optical encoding means comprise a spatial modulator array comprising an array of optical keys each adapted to be switched between closed and open positions thus either allowing or preventing passage of light through it, and a transformer array comprising an array of optical units each optical unit adapted to reflect incidental pulse in the form of a series of pulses forming an encoded beam corresponding to said at least one of a plurality of characters, wherein the spatial modulator array and the transformer array overlap in such a manner that each optical key of the spatial modulator array corresponds to a single optical unit of the transformer array.

Furthermore, in accordance with another preferred embodiment of the present invention, the illuminating means comprises a femtosecond laser source and synchronizing means for synchronizing the generation of the first light beam with the operation of the spatial modulator array, so that the generation of a femtosecond pulse coincides with the actuation of the spatial modulator array.

Furthermore, in accordance with another preferred embodiment of the present invention, said apparatus includes a writing head comprising a first and a second high-quality high numerical aperture lenses, arranged in such a way that the first lens' forward focal point coincides with the second lens' forward focal point in a predetermined position so as to allow recording of the encoded beam in a predetermined portion of the medium; and diverting means for optically diverting the encoded first light beam to the first lens of the writing head and for optically diverting the second reference beam to the second lens of the writing head.

Furthermore, in accordance with another preferred embodiment of the present invention, said apparatus includes adjusting means for adjusting the timing and amplitude of the series of pulses of the encoded beam and the reference beam.

Furthermore, in accordance with another preferred embodiment of the present invention, said illuminating means generate light beams of sufficient power to locally change at least one of the optical characteristics of a medium selected from photoemulsion, porous glass containing photosensitive matter, conventional optical glass or silica.

Furthermore, in accordance with another preferred embodiment of the present invention, the apparatus further comprises shifting means for shifting the medium so as to allow writing optical information in different locations within the medium.

Furthermore, in accordance with another preferred embodiment of the present invention, the directing means comprise inter alia dichroic mirror so as to allow a polarized portion of the first light beam to pass while reflecting the rest.

Furthermore, in accordance with another preferred embodiment of the present invention, a quarter-wave plate or film is provided to transform plane-polarized light to circularly-polarized and vice versa.

Furthermore, in accordance with another preferred embodiment of the present invention, the apparatus also includes attenuators and optical delay lines for tuning the system, and collimators and condensers.

Furthermore, in accordance with another preferred embodiment of the present invention, there is provided an apparatus for reading information stored in a photosensitive transparent medium in a form of a stack consisting of at least one of a plurality of layers of optical properties inhomogeneities of the medium corresponding to at least one of a plurality of characters comprising:

illuminating means for generating a first reference light beam directed at the stack in the medium;

receiving means for receiving light reflected from the stack; decoding means for decoding the reflected light by comparing the reflected light with at least one of a plurality of optical patterns corresponding to a plurality of characters so as to recognize said at least one of a plurality of characters.

Furthermore, in accordance with another preferred embodiment of the present invention, said illuminating means comprises a femtosecond pulse generator for generating a beam of femtosecond pulses, a beam splitter for splitting the laser beam into a first and a second beam, the second beam being a source for auxiliary synchronous signals.

Furthermore, in accordance with another preferred embodiment of the present invention, the receiving means comprises a reading optical head comprising a high-quality high numerical aperture lens, arranged in a way that the lens' forward focal point is in a predetermined position so as to allow illuminating the plurality of layers of optical properties inhomogeneities in a predetermined portion of the medium.

Furthermore, in accordance with another preferred embodiment of the present invention, there is provided a method for providing optical information storage in photosensitive transparent medium, comprising the steps of

providing illuminating means for generating a first light beam for carrying encoded optical patterns and a second light beam for serving as a reference beam;

providing optical encoding means for encoding the first light beam so as to carry a sequential pack of ultrashort pulses corresponding to said stream of at least one of a plurality of characters and for encoding the second light beam so as to carry a reference optical signal:

providing directing means for directing said first beam and second beam substantially in counter-propagating directions and focusing them at a predetermined location within the medium so as to form a focal waist within said medium enabling interference between the two beams at a predetermined location within the medium;

encoding a flow of information to a sequential pack of ultrashort pulses

focusing said sequential packs of ultrashort pulses and aiming said sequential pack of ultrashort pulses at a predetermined location within the medium;

focusing the reference beam and directing the reference beam opposite to the propagation of said sequential stream of ultrashort light pulses so as to allow their meeting at the predetermined location within the medium causing interference pattern to be formed within the medium at that location causing the formation of optical inhomogeneities within the medium.

Furthermore, in accordance with another preferred embodiment of the present invention, the method further comprises providing shifting means and shifting the medium so as to allow writing optical information in different locations within the medium.

Furthermore, in accordance with another preferred embodiment of the present invention, there is provided a method for the optical reading information stored in photosensitive medium using the method of writing of the present invention, comprising the steps of.

providing illuminating means for generating a first reference light beam directed at the stack in the medium,

providing receiving means for receiving light reflected from the stack;

providing decoding means for decoding the reflected light by comparing the reflected light with at least one of a plurality of optical patterns corresponding to a plurality of characters so as to recognize said at least one of a plurality of characters;

directing said reference beam and focusing it onto the location within the medium where the information was previously inscribed;

directing the reflected light from the medium via a waveguide to the decoding means to determine the information.

Furthermore, in accordance with another preferred embodiment of the present invention, the decoding means comprises an array of optical units each optical unit adapted to reflect incidental pulse in the form of a series of pulses forming an encoded beam corresponding to said at least one of a plurality of characters.

Furthermore, in accordance with another preferred embodiment of the present invention, the illuminating means comprise a femtosecond laser.

Finally, in accordance with another preferred embodiment of the present invention, the medium is provided with a quarter-wave layer or film

### BRIEF DESCRIPTION OF THE FIGURES

In order to better understand the present invention, and appreciate its practical applications, the following Figures are provided and referenced hereafter. It should be noted that the Figures are given as examples only and in no way limit the scope of the invention as defined in the appending Claims, Like components are denoted by like reference numerals.

FIG. 1a illustrates a typical set of ultrashort pulses representing the initial information flow in accordance with the present invention.

FIG. 1b illustrates a reference pulse in accordance with the present invention

FIG. 2 is a schematic diagram of a writing apparatus in accordance with a preferred embodiment of the present invention.

FIG. 3 depicts the structure of the focal waist created by the light beams in the photosensitive medium after being exposed to the combination of pulses in accordance with the present invention.

FIG. 4 illustrates a schematic diagram of an apparatus for reading information in accordance with a preferred embodiment of the present invention.

FIG. 4a illustrates illumination of the stored stack with a femtosecond pulse identical to the reference pulse in accordance with the present invention.

FIG. 4b shows the formation of a “character” as the result of back scattering (or reflection) of the pulse from a set of layers of the stack.

FIG. 5 illustrates the inner structure of a wave-guide in accordance with the present invention designed to produce three reflections supplementary to the initial sequence.

FIG. 6 shows the formation of the signal reflected from the wave-guide.

FIG. 7 illustrates a schematic diagram of the optical head for a unidirectional mode of operation.

FIG. 8 illustrates propagation of a set of pulses within the photosensitive medium,

FIG. 9 shows a general view of the information writing apparatus in accordance with a preferred embodiment of the present invention

FIG. 10 illustrates an apparatus for reading and recognizing a “character” having the same pattern as the apparatus of FIG. 9.

FIG. 11 illustrates an apparatus for reading and recognizing one “character” having the pattern conjugated to the “character” of FIG. 9.

FIG. 12 demonstrates the recognition of the “character” from the flow of information with the same set of “characters”.

FIG. 13 illustrates a typical scheme of an apparatus for writing information into photosensitive medium arranged with a mirror

FIG. 14 demonstrates a schematic diagram of an apparatus for reading information from the mirror-arranged optical ROM in accordance with a preferred embodiment of the present invention.

FIG. 15 is a schematic diagram of an apparatus for writing and reading of information incorporated in one device.

### DETAILED DESCRIPTION OF THE INVENTION AND FIGURES

The present invention uses alternative optical effect to write the information in a transparent medium, namely optical interference.

The present invention eliminates the problem of mechanical tuning of the beam or of the set of beams of light employed for the processes of reading and writing the information.

The present invention allows writing and reading information in “characters” (or bytes) rather than bit-to-bit.

The present invention applies effective methods of optical compression of information and pattern recognition to achieve maximum rate of operation and maximum reliability of reading/writing.

The medium that the present invention deals with needs to be transparent so as to allow light waves of predetermined frequencies to pass through at least a portion of the medium, so as to facilitate penetration of light deep enough inside the medium.

The present invention employs local changes of optical characteristics of a given transparent medium such as its refractive index, absorption coefficient, optical activity (rotation of polarization plane or birefringence) or scattering abilities, such as occurring in the optical breakdown phenomenon, in which applying locally concentrated energy above a damage threshold value, which is distinct for different kinds of materials, renders a transparent material to change its optical property, becoming “opaque” By “opaque” it is meant, in the context of the present invention, any change in the optical properties of the medium in a predetermined location resulting in deterioration in the intensity, polarization or phase of light passing through the medium through that location. For example, typical damage threshold for fused silica are about 200 J/cm² for 10 ns, 10 J/cm² for 30 ps and 3 J/cm² for 100 fs pulses (An-Chun Tien et al Phys.Rev. Letters, v.82, pp.3883-3886, 1999).

As indicated before, a main aim of the present invention is to provide a solution for the existing contradiction between the ability to obtain great density of information storage and the need for fast reading of the stored information. The present invention aims also at effectively increasing the rate of storing and reading of information.

The feasibility of using effective digital encoding system for a new type of holography, based on femtosecond pulses of light has been discussed by M K Lebedev and Yu.A.Tolmachev, the inventor of the present invention (“Holography using wave process with zero coherence length”, Optics and Spectroscopy, Vol. 83, #5 (1997), P. 763, and “The application of temporal coding in δ-holography”, Optics and Spectroscopy, Vol. 82, #4 (1997), P. 629) In the method described, two counter-propagating wide beams of light were used. First of them was the single-pulse reference plane wave and the second was the encoded object wave carrier,

For the realization of that method in the present invention, a stream of information is resolved into a set of patterns of plural information elements that corresponds to the information of predetermined type (“characters”). Any “character” is presented as a sequence of femtosecond pulses in time that is the code for that “character”. In a simple case of the present invention, a binary code may be used. For a coherent writing/reading mode, it may consist of +1, 0 and −1, for a non-coherent mode one only 0 and 1 are possible.

In order to write information in a volume of a transparent medium, two spatially and time coherent beams of light consisting of femtosecond pulses, in particular, are generated, directed one to another in the counter-propagating way and focused to a single focal point. Those beams form a general focal waist inside the bulk of photosensitive material.

The first beam carries the “character” and the second is needed to write down this “character”. A single femtosecond pulse or a sequence of pulses may be used for the reference beam. When using a continuous flow of the stochastic white light (as suggested by Lebedev and Tolmachev), the same encoding and decoding systems are to be used. The interaction of the two counter-propagating beams produces an interference pattern that is recorded within the single focal waist inside the bulk of photosensitive matter (the medium), for example photoemulsion, porous glass filled with photosensitive matter, convenient optical glass or silica for optical breakdown writing (good only for +1 and 0), etc. A set of maxima and minima (i.e. extrema) of the scattering coefficient, or refraction index, or some other optical characteristic of the matter are induced in the matter at the location of the focal waist. This set of extrema forms the stack representing the “character”. It may consist of +1, 0 and −1 for digital encoding. The latter −1-case means that the oscillations of spatial characteristics induced by the wave are in counter-phase with respect to those for +1. Summation of two pulses having different sign results in zero value.

When two pulses generated by two non-coherent sources are used to produce the stack of information, (see Strickler), a nonlinear interaction of light with matter will also result in the formation of the set of inhomogeneities. Because of the absence of relative “phase” of the inhomogeneities, only 0 and 1 can be stored in this case

In the present invention two methods are employed for reading the recorded information. Those methods are technically different in their realization but similar in their principle.

The first method uses a pulse of light, or a sequence of pulses, or an encoded white light similar to the reference one This light is directed into a stack stored within the photosensitive medium, using lens. The sequence of pulses, or the continuous encoded flow of light reflected from the previously recorded maxima and minima of material properties of the photosensitive medium is compared with the pattern representing the “character”, which is stored in the memory of the reading device comprising an array of optical units in accordance with a preferred embodiment of the present invention.

The second method of “character” recognition uses for a probe pulse illumination a sequence of pulses or an encoded light flow that is supplementary with respect to the “character” as it is recorded in the stack. In the process of the sequence of pulses reflection, a single great pulse is formed that is the symbol of the coincidence of the recorded “character” and the probe one. In the continuous mode, the maximum of reflection of the encoded white light is observed.

It is understood that by employing the apparatus and methods of the preceding inventions (for example Glezer) one can store as much information in the bulk of some transparent matter as the theory shows. The amount of stored information can be tremendous, but to read out the information needed, one must look through thousands of pages, even transparent, containing a lot of useless data not needed at the particular moment and yet masking the needed one. In reality, it is evident that there exists an optimum between the amount of information stored and time to retrieve and read it.

The aim of the present invention is to provide a solution for this contradiction, and to point out rather simple ways to fast and reliable reading of great portions of information (presented in a form of the so-called “characters”) stored in some carrier, for example transparent matter. The apparatus and method of the present invention also effectively increases the rate of storing the information.

The method and apparatus of the present invention can operate with any flow of light whose spectrum is sufficiently broad to create a fine and well-concentrated pikes of an interference pattern in the vicinity of zero-path difference between two beams. There are currently two types of sources of light that fit this condition. The first one is the convenient source of white light that can be generated from a lamp, white-light photodiode, a set of colored photodiodes properly combined to emit white light, or the so-called “white” lasers. The other light source is a femtosecond laser capable of emitting a pulse containing only a few oscillations. Femtosecond lasers are recommended because of the great brightness (or power) associated with them. For the purpose of explaining the present invention and demonstrating some of its aspects a femtosecond laser is considered to be the light source in the description of the mode of operation in the embodiments discussed and shown in the Figures.

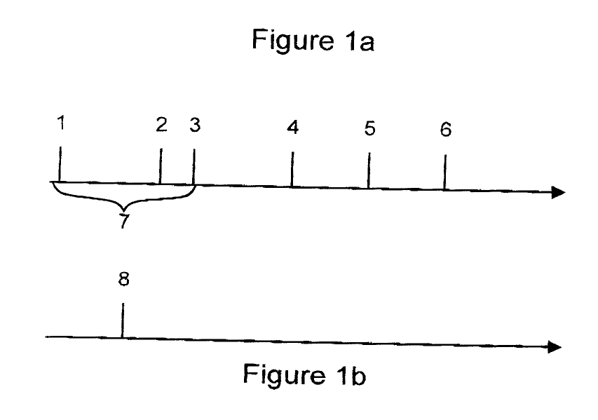

Consider a chain of identical femtosecond pulses containing some information (FIG. 1a). Let the group marked at FIG. 1a to represent “character” <a>. To simplify the picture, take a single femtosecond pulse to be a reference pulse (FIG. 1b). At this stage we shall ignore that the spectral components of the pulse have their phases and the form of the pulse is the result of their interference- The positive pikes shown in FIGS. 1a and 1b are the marks of the beginning of the pulses, the lines shown as positive mean that no change in the inter-phases relation inside the pulses exists- The negative lines will show pulses having all spectral components in the counter-phase with respect to positive. A set of pulses representing the initial information flow is denoted by numerals 1, 2, 3, 4, 5 and 6, pulses 1, 2 and 3 forming together the “character” 7 to be considered. Note that by “information flow” it is meant a flow consisting of separate “characters”.

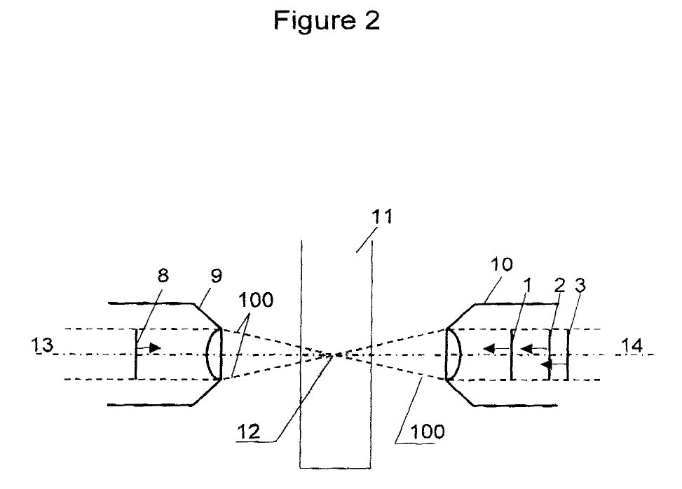

The key device (and the main aspect) of the present invention is a write-and-read optical head. A write-and-read optical head for writing the “character” comprises two high-quality high numerical aperture lenses, arranged in a way that one lens' forward focal point coincides with the other lens' within a photosensitive matter used for recording the information (see FIG. 2). By “high-quality” lens it is meant a lens compensated for all known aberrations including group velocity aberrations, and by “high-numerical” aperture it is meant aperture greater than 0.3. The focal waists of those lenses are overlapping and aligned. Once tuned to this position, the lenses are fixed at all times. In FIG. 2 numerals 9, 10 are denoted to the lenses, 11 is a transparent photosensitive matter, 12 is the focal waist of two lenses, 13 is the reference beam, and 14 is the <a> “character” carrier.

Two sets of pulses propagate one against the other and meet somewhere within the matter. To get the maximum writing density, the sets must be tuned in a way that the center of the waist must correspond to the center of the bulk. The photosensitive matter of the bulk may be linear with respect to the amplitude or intensity of light.

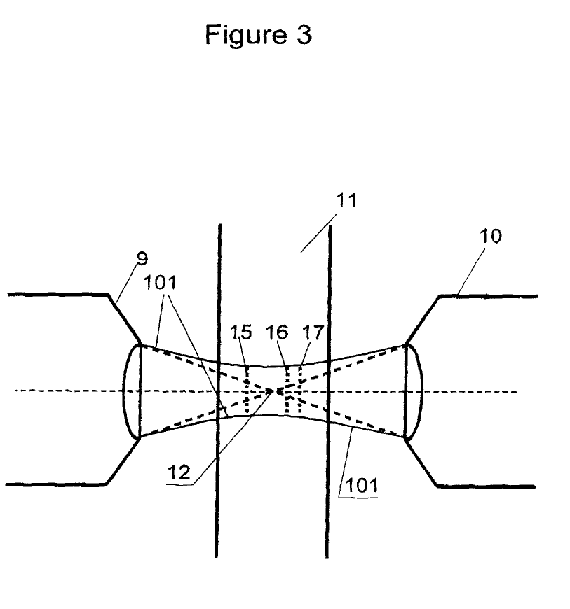

Propagating independently, the two sets of pulses create a uniform background exposure of the photosensitive matter within the focal waist, At certain locations where the pulse of FIG. 1b meets the pulse set of FIG. 1a layers of inhomogeneities of the optical parameters of matter (transparency, scattering and reflection coefficients, or refractive index) will be induced. The optical distance between the lamellas will be one-half of that between the pulses of the <a> set. FIG. 3 shows the spatial structure of matter in the vicinity of the waist after the exposure. Dashed lines 100 in FIG. 2 show the boundary of the beams in the vicinity of the waist given to the geometry optics approximation. In FIG. 3 solid lines 101 define the real boundary caused by the diffraction of pulses form the lenses. Dotted lines 15, 16, 17 show the lamellas of greatest exposure. Those lamellas are maxima caused by the interference of pulse set 1, 2, 3 with pulse 8. Compare them with 7 given in FIG. 1a for the <a> “character”. Note that when matter linearly photosensitive to exposure is used, the record may consist not only of maxima but minima too may be present. Those maxima lamellas correspond to +1, minima lamellas correspond to −1 and the uniform background corresponds to zero. Each layer may consist of several spatial oscillations of the optical characteristic When a combination of pulses is used for the reference beam of light, the structure of layers becomes much more complicated.

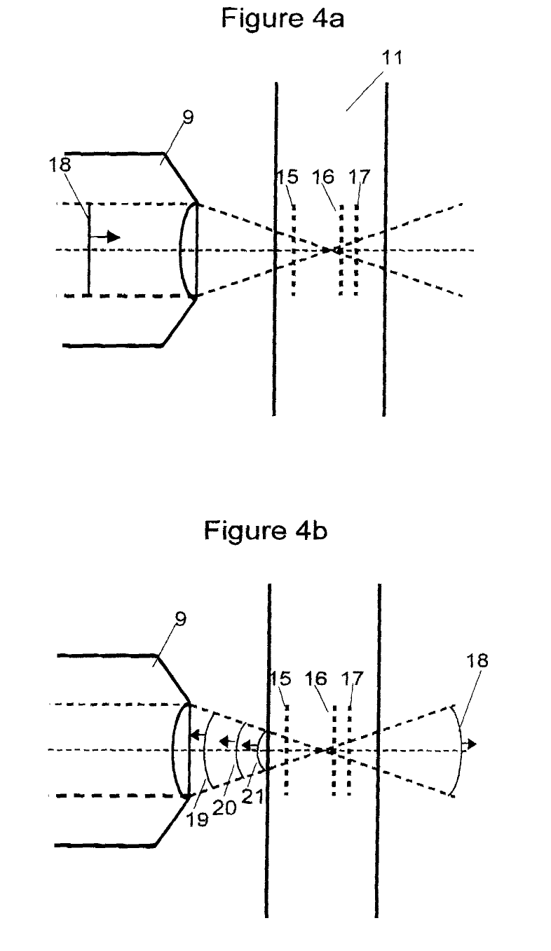

In order to read the recorded “character”, the stack is illuminated with a reference beam 18 same as the reference beam used in the writing, directed from the left (FIG. 4a), and a sequence of pulses 19, 20 and 21 reflected (or scattered backwards) from all lamellas inside the matter is observed (FIG. 4b), some of the pulse 18 traversing through the matter. The three reflected pulses 19, 20, 21, are the same sequence of pulses that was recorded (multiple reflections from the slightly-reflected layers produce much more weak pulses and can therefore be neglected). This is the stage of restoring the “character”

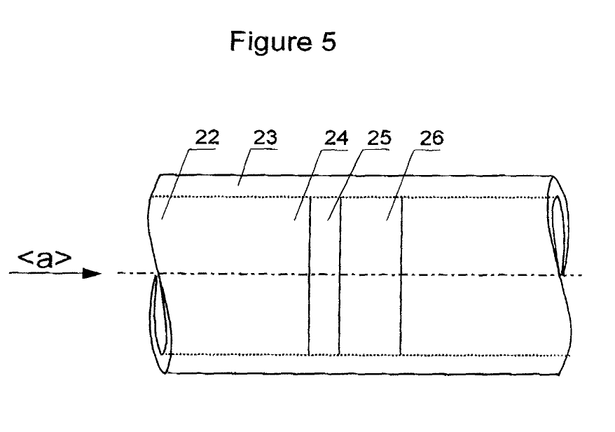

The next stage is to recognize the “character” <a>. To accomplish this, one must decode the sequence of reflected pulses of light, i.e. to compare It with an optical pattern corresponding to the same “character”, which is stored in the memory of the decoder. This stored pattern consists of a set of reflectors (or the inhomogeneities of parameters of matter) that produces the reverse sequence for the reconstructed pulses. For example, it may be a decoding wave-guide consisting of a central filament (core) 22 and a cladding 23 which refractive index n₂ is less then n₁ of the core. Refractive index of the core varies along the axis as shown in FIG. 5. In FIG. 5 core 22 of the wave-guide (having cladding 23) has three reflecting boundaries 24, 25, 26 separating zones of different refractive indices n₁>n₁′>n₁″>n₁′″. Such a variation can be achieved using ion implantation technique.

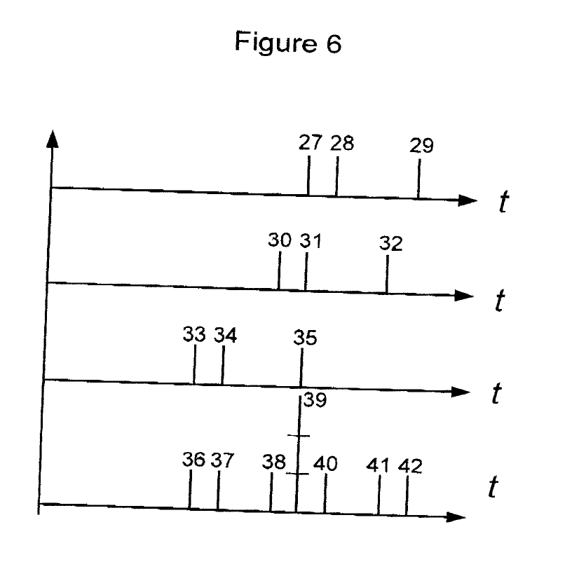

The process of recognition of the sequence <a> is demonstrated in FIG. 6 Consisting of three pulses at different distances one from another, this combination is reflected three times from three boundaries formed of contacts of matter with different refractive indices. Pulse set 27, 28 and 29 is the “character” <a> reflected from boundary 24. Pulse set 30, 31 and 32 is the “character” <a> reflected from boundary 25. Pulse set 33, 34 and 35 is the “character” <a> reflected from boundary 26. The set of pulses 36-42 is the resultant sequence of pulses corresponding to the sum of pulses 27-35.

Relative amplitudes of the pulses are shown with the length of the line orthogonal to t-axis.

Those pulses overlap inside the central filament of the wave-guide to form one great pulse 39 surrounded by pulses substantially smaller in amplitude (in the example of FIG. 6 three times less). Photo receivers that are employed measure not the amplitude but the energy of those pulses, so the difference between the detected greater pulse from the other detected pulses is the square of three, i.e. nine times that is sufficient to minimize the possible recognition error.

Another way of recognition starts from the illumination not of the stored stack but of the pattern stored in the reading out system with the reference beam (a single pulse or a sequence of pulses that was used in the writing of the “character”). Then the set of pulses of light reflected from the pattern is directed onto the stack containing the “character” recorded in the bulk. Similarly to the above referenced process, the single great reflected pulse will be observed only under the condition of coincidence of the sequence reflected form the pattern and the “character”.

The same applies for non-coherent method of information reading Special types of codes, such as Barker code, for example, are rather efficient in this case It was noted that coherent methods are capable of producing a single pulse for recognition of much greater contrast then non-coherent ones

The method of writing and reading information of the present invention requires adjusting of the optical system only once, but it demands precise transportation of the matter to inscribe sequentially many characters. Immersion liquid that is inserted between the lenses and the matter for compensating the variation of optical path length may cause additional problems Special attention has to be paid to fixation the distance of photosensitive matter from either one of the lenses of the optical head

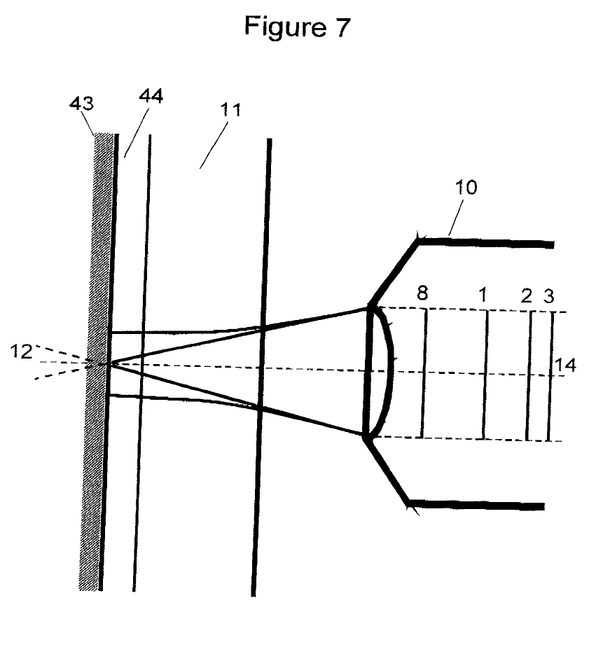

In order to overcome this problem, a slightly modified system is considered. Consider a part of CDROM 11 placed in front of the lens (FIG. 7). This CDROM differs from the usual one in three aspects. First, a mirror 43 is positioned on the far side of the CDROM (and not the front as would be expected). Second, a thin layer of optically active matter 44 that transforms plane polarized light to circularly polarized one (so called quarter-wave plate) is placed in appropriate way between mirror 43 and layer 11 of matter designed for storing the information (i.e. the CDROM). Third, layer 11 is much more thick then in usual CDROMs. To write down a character whose length is 300 microns in the air (that is in fact a 1000 femtosecond long speech) one needs approximately 100 microns-thick layer of photosensitive matter.

To distinguish the reference pulse from the information ones, the sequence of pulses <a> is transformed into a sequence of plane-polarized waves. This sequence is provided with an additional pulse that plays the role of the reference pulse- Polarization of the reference pulse is orthogonal to that of pulses to be recorded. The optical distance of the reference pulse from the “character” is twice the optical thickness of the quarter-wave plate. Note that a combination of the orthogonal circular-polarized pulses may be used also.

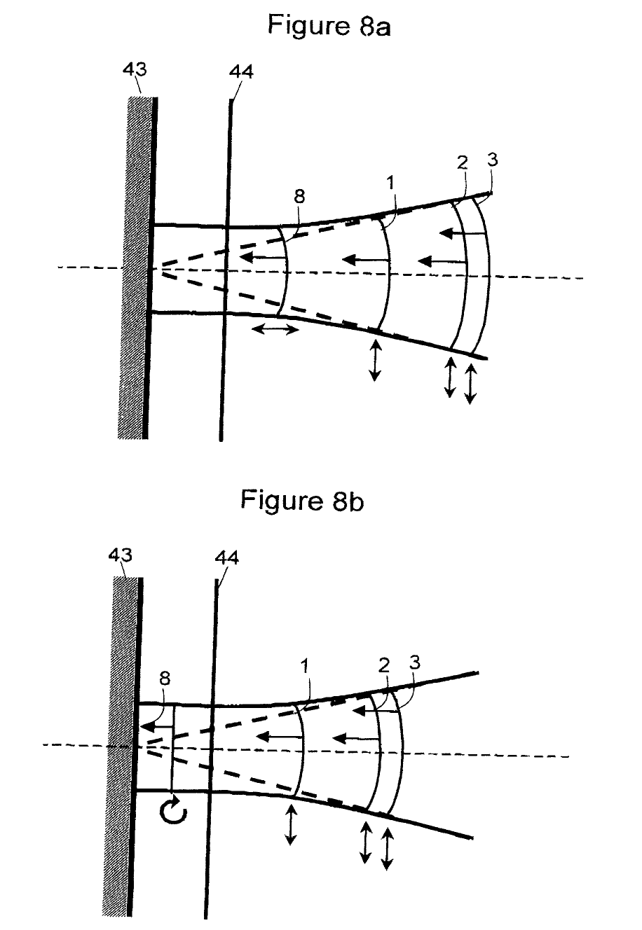

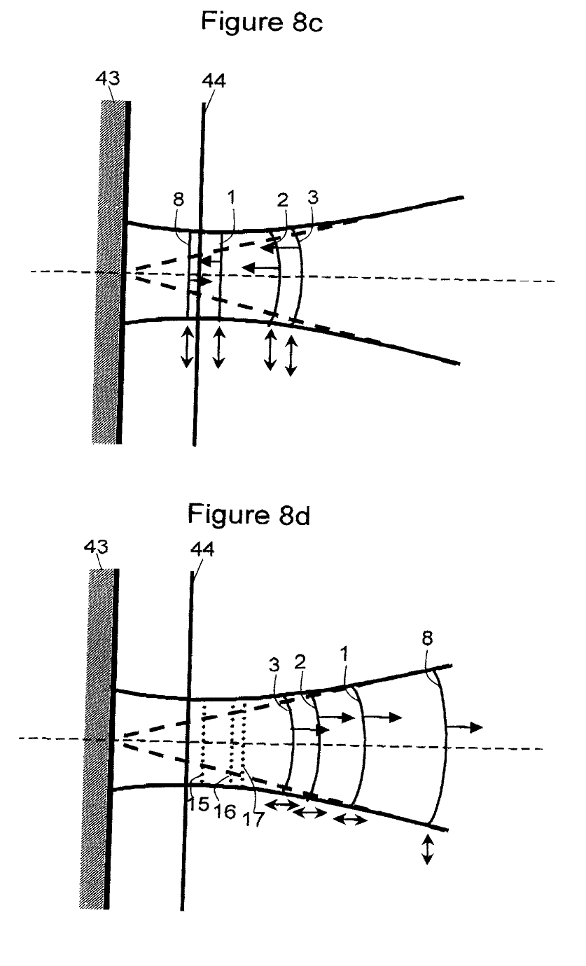

Operation of the apparatus of the present invention and implementation of the method of the present invention is demonstrated in FIGS. 7, 8 The optical memory system consists of photosensitive matter 11 in a form of thick layer, quarter-lambda layer 44 and mirror 43. A beam of light 14 containing the “character” <a> consisting of femtosecond pulses 1, 2, 3 is added to reference pulse 8 and is directed through the optical head onto the memory layers combination. The sequential positions of the pulses within the photosensitive medium are shown schematically in FIGS. 8a to 8d, the polarization of the pulses being also indicated. In FIG. 8a all of the set of pulses is already in the photosensitive medium but has not yet reached the quarter-lambda layer. All waves are plane-polarized. In FIG. 8b the reference pulse is shown to reach the mirror, only this pulse becoming circularly polarized The next stage when the reference pulse is ready to come out from the quarter-lambda film after the reflection is shown in FIG. 8c, this pulse becoming plane-polarized once more, orientation of its plane of polarization being the same as in all the pulses of the “character” <a>. Those counter-propagating pulses become capable of interfering. The interference pattern formed in the photosensitive medium after the interaction of the reference pulse with <a> set is shown in FIG. 8d

Reading operation for the process illustrated in FIGS. 7 and 8 does not differ significantly from that described earlier with reference to FIGS. 4, 5, and 6. There is a great difference in the form of signal is reflected from the set of layers caused by the existence of a mirror in the CDROM. For the plane-polarized illuminating wave, the reflected beam of light will consist of an inverted <a> sequence of pulses of small amplitudes combined with the great reference one formed in the reflection of the initial pulse from the mirror. This latter pulse will have its polarization plane orthogonal to all others. Such a difference permits to direct the reference pulse and <a> sequence through different channels using well-known methods of the wave-guide optics and to use it for switching the electronic components of the apparatuses When the supplementary sequence is used for pattern recognition, the single great intensity pulse will be formed in the reflection. The parasite multiple reflections from the mirror have orthogonal polarization and can be suppressed or used for other purposes.

This version of the method of the present invention possesses the initial “clock” to fix the interval between the reference pulse and the signal, this interval is fixed by the construction of the CD (the bulk layer and the quarter-wave layer thicknesses) and does not depend on displacement of the memory system of layers with respect to the optical head, that provides better stability and makes it easier for the realization in practice The simplification associated with the setup as shown in FIGS. 7 and 8 causes some reduction in the amount of recorded information. One can easily see that to realize the same density of the information storage in this method, the optical thickness of the quarter-wave layer is to be the same or greater than that of the photosensitive medium to get the appropriate delay between the reference pulse and the set of information pulses.

While considering the writing of the series of pulses we left aside the problem of pulses amplitude writing and reconstruction, When the photosensitive medium is used whose sensitivity is linear with respect to amplitude of light, the ability of the method to reconstruct the full information on pulse amplitude is obvious. For such a medium one can take a photoemulsion or a porous glass filled with the same species that are used for photoemulsion. Now let the distance between the pulses become shorter approaching zero. One obtains the continuous signal that can be recorded and reconstructed from the stored record at any moment needed So the same method of the information storage can be applied also to a continuously modulated white-light waves.

Up to this point, coherent methods were considered, and amplitude of the electric field of wave was the main factor taken into account. Linear reaction of photosensitive medium to the amplitude of light was shown to be enough to record the interference pattern and to recognize the “characters” The nonlinear interaction of light with matter for “character” recording brings about prospects for additional embodiments of the method and apparatus of the present invention.

Consider FIG. 2 to be the scheme of apparatus for the non-coherent writing of information in accordance with the present invention. Two beams of light 13, 14 are now non-coherent, having either the same or different mean frequencies. There exists a number of photosensitive media possessing the intensity threshold with respect to writing ability (see Stricker and Swainson for example). In these types of media, when two or more photons arrive simultaneously to the same location there occur some variation of the optical properties of the medium in this location. Summation of incoherent photons means the addition of intensities. When only one beam or one pulse of light illuminates the matter, there are no changes of optical properties of the medium as a result. Two photons produce the change in the refractive index, transparency or scattering coefficient of matter. In FIG. 2, the counter-propagating pulses meet each other only in the very small areas coinciding with those marked in FIG. 3 as 15, 16, 17. No standing waves are formed there, only the coincidence of the pulses in space that produces the optical parameter variation within the contour (the envelop) of the non-stationary interference pattern that would be obtained under the conditions of coherent illumination. Their time/spatial structure is recorded in some amplitude scale as a result of the summation of the intensity of pulses at the same places as previously.

In the embodiment of the present invention as shown in FIGS. 7 and 8 each pulse can differ in its mean frequency from the others, the total intensity of the sum of pulse 8 with any of 1, 2, 3 is to be greater then the threshold of matter. Different but synchronized sources can be used to form the “character”

There is no significant difference in the processes of “character” reading out for the non-coherent case. Scattering of pulses of light from thin layers representing the “character” change the form of pulses or the phase of waves when white-light continuous process is used to restore the information.

Note that all the described ways of “character” recognition can be applied to read the information recorded with the use of other technologies such as the one developed by Calimetrics (Beyond DVD, Popular Science August 1997, Pg. 55), or described in U.S. Pat. No. 4,985,885 to Ohta et al, all incorporated herein by reference.

Hereafter, a detailed description of an apparatus in accordance with the present invention is given. It is important to realize that in the accompanying Figures the optical setup is simplified in order to render the explanation simple and straight-forward. It is obvious to a person skilled in the art that incorporating integrated optics would be the sensible thing to do. There are well known and widely used integrated optics elements such as planar beam splitter, optical keys, polarizers, photo-detectors etc. These integrated optical elements should be considered in the realization of the embodiments of the present invention.

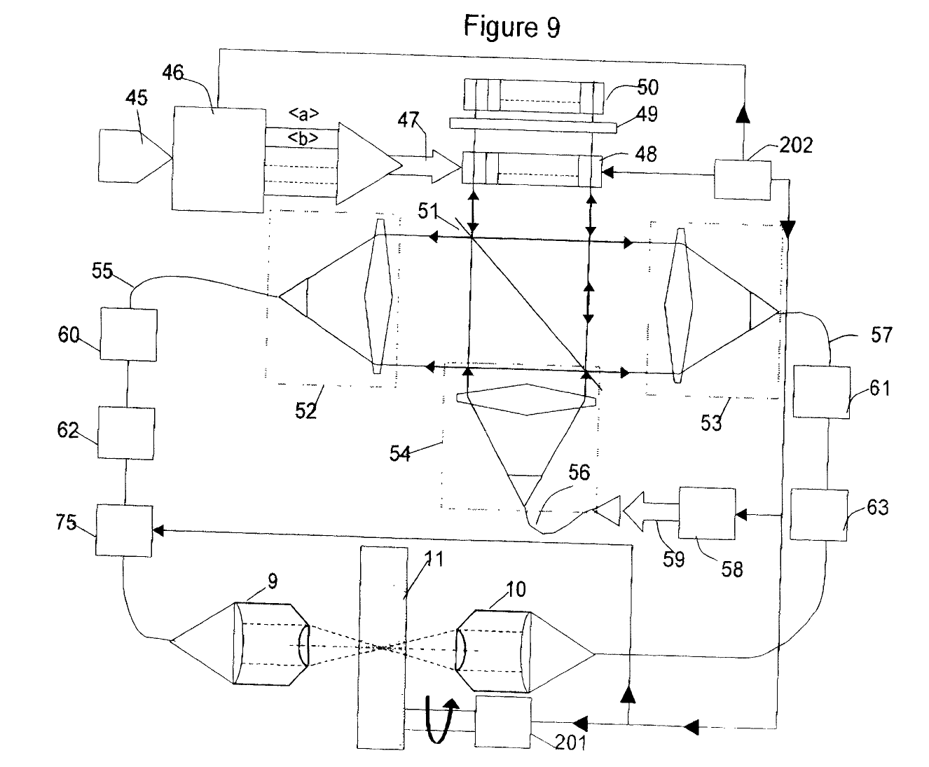

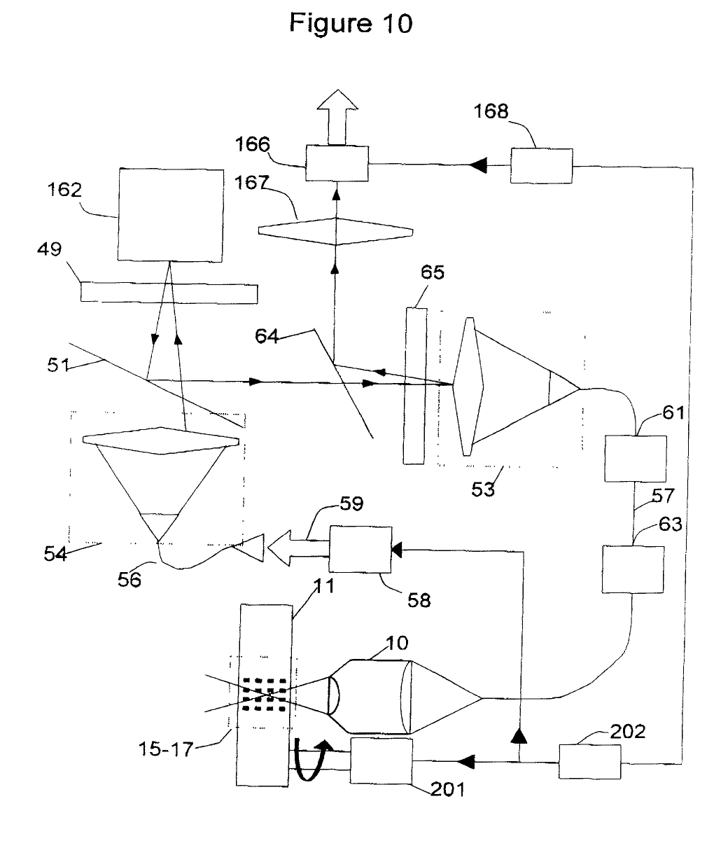

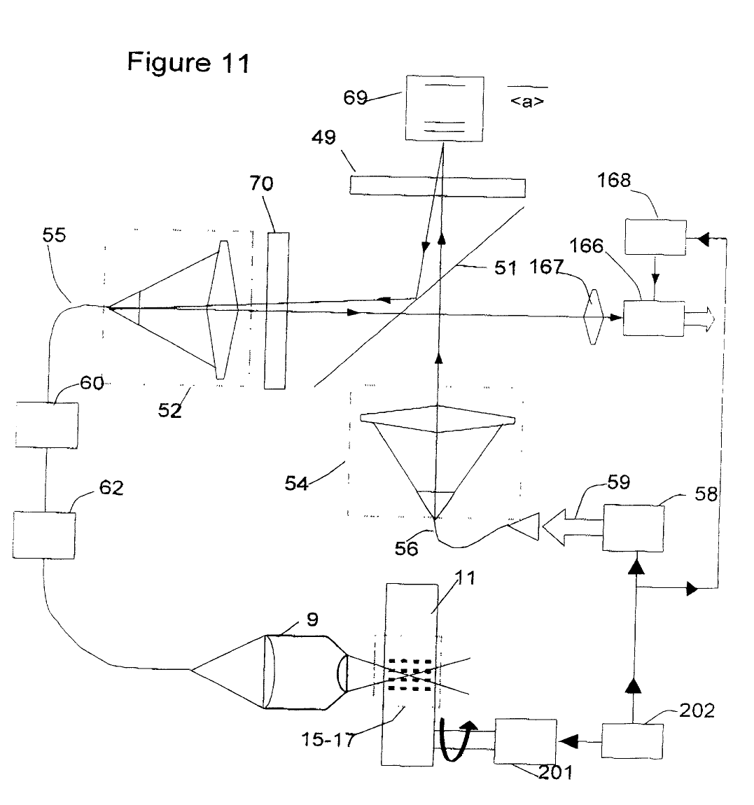

FIGS. 9 and 10 show two embodiments of the inscription of information in the photosensitive matter, FIGS. 11 to 14 depict different embodiments for reading the information stored in the medium. In all cases femtosecond pulses are supposed to be used. In some cases continuous sources of white light for writing and reading the information may be also used.

The most general scheme of the setup for writing is depicted in FIG. 9 An information flow 45 may initially traverse through some electronic or optical device 46 acting as an encoding system so as to divide the flow of information into “characters”, and the control signals are directed into different outputs through a connection circuit 47. These signals control a spatial modulator array. The spatial modulator array comprises an array of optical keys (or shutters) 48, each adapted to be switched between closed and open positions thus either allowing or preventing passage of light through it, is provided. A transformer array comprising an array of optical units 50, each optical unit adapted to reflect incidental pulse in the form of a series of pulses or a single pulse having the appropriate position in time, the series corresponding to a predetermined character, is provided. The spatial modulator array and the transformer array overlap in such a manner that each optical key of the spatial modulator array corresponds to a single optical unit of the transformer array

The modulator array may be for example a high-speed spatial light modulator consisting of an LC array combined with a polarizer filter can be custom-made and obtained, for example, from Central Research Laboratories (CRL) Ltd., Hayes, Middlesex, UK. In principle, the high-speed LC array are based on ferroelectric LC technology, and comprise an array of LC cells that are each controlled and may be switched to the polarization plane rotated mode thus changing the transmittance of the system's “cell—polarizing filter” from transparent to opaque. Each key switches one “character” channel Light to be switched comes from laser 58 as a beam 59 through a wave-guide 56 and through optics 54 so as to broaden up the beam in order to illuminate all of keys 48. This light is non-polarized from the very beginning and falls onto a beam splitter 51 directing the two orthogonally polarized beams into different optical branches, a dichroic mirror is suitable in our explanation of the system operation, a set of planar wavegide beam-splitters may be used for this purpose in the integrated optics mode realization. A portion of the flow comes through the mirror and becomes plane-polarized, the rest is reflected and is also plane-polarized with the orientation of this plane orthogonal with respect to the transmitted radiation. The beam transmitted by mirror 51 illuminates the array of keys 48. The control signal generated from the electronic device 46 actuates the key array so as to allow opening of a single or a combination of keys. The transmitted light is illuminated on optical units corresponding to the open keys and each illuminated optical unit reflects the incidental light in a distinct manner producing a pulse or a distinct series of pulses. For example the array of patterns may comprise an array of waveguides each adapted to reflect a distinct combination of pulses corresponding to a character (see FIG. 5)

The optical units may be a combination of quarter-wave plate 49 and an array of waveguides (to form the so-called optical ROM for “characters”) is arranged so as to reflect light transferred by the key backwards changing its polarization on two passes (to and fro) through it to be orthogonal to the incident light. The changing of polarization is required to facilitate diversion of the reflected beam from the dichroic mirror in the direction of the condenser 53. Any other form of diversion may be possible

On opening one of the keys the femtosecond pulse of light passes the quarter-wave plate 49 and becomes circularly polarized. The series of pulses reflected from inhomogeneities inside the selected pattern possesses circular polarization too. It comes through the quarter-wave plate once more and becomes plane-polarized, the plane of polarization of the pulses now orthogonal to the previous orientation that makes all of them reflect from mirror 51 to come to wave-guide through the condenser 53.

On its way to the writing head 10 through the waveguide 57 the delay line 61 and attenuator 63 are placed for the adjustment of the moment of pulses coming to photosensitive medium and appropriate amplitude. Identical system consisting of the delay line and attenuator is placed into the reference beam channel, in the most general case, any of them can be omitted under appropriate selection of optical parameters of the communication line.

The portion of the beam reflected from dichroic mirror 51 through condenser system 52, waveguide 55, delay line 60, attenuator 62 comes to the reference beam lens 9. Two beams previously tuned in time and amplitude with delay lines 60, 61 and attenuators 62, 63 meet inside the photosensitive medium 11 to produce the record of the “character”. A fast optical key or isolator 75 may be included into this optical chain, if needed to prevent from the femtosecond pulses circulation through the whole system. This optical key may be the electro-optical shutter using the Pockels or Kerr effects, the optical isolator may use Faraday effect, for example.

The medium may then be optionally shifted so that a different portion of it is positioned in the coinciding waists. A motor 201 shifts the medium (in a case of a CD the motor drive rotates the CD, but linear or any other type of shifting is possible). The unit 202 synchronizes the operation of the system as a whole.

For reading the stored information two alternative ways are suggested.

FIGS. 10, 11, 12 show the scheme of these methods realization. In FIG. 10 the reading and recognition of a single and well-known “character” recorded with the similar sequence of pulses is shown, for better understanding. The pattern for this “character” is kept in stack 162 that is one component of the set 50 (FIG. 9). A femtosecond pulse of non-polarized or plane-polarized light 59 comes from laser 58 to the collimator 54 and then passes through dichroic mirror 51 and quarter-wave plate 49 to pattern 162. Reflected from pattern 162 series of pulses falls onto the mirror 51 and is directed to the condenser system 53. On its way it passes through the auxiliary dichroic mirror 64 and quarter-wave plate 65, so that the circularly-polarized light comes through the waveguide 57 to the reading head 10 that is identical to the writing head. The back-scattered light from layers 15-17 consists of a sequence of series of pulses that combine, as a result of interference, into one pulse of great amplitude surrounded by smaller ones. The combination of pulses returns to quarter-wave plate 65, On passing this plate, these pulses become plane-polarized, the orientation of the polarization plane orthogonal to the previous one. Now those pulses are reflected from the auxiliary dichroic mirror 64 and come to the photo-detector 166 provided with the lens 167 collecting light. The photo-detector 166 possesses a threshold that is controlled with electronic set 168 to discriminate the pulses of smaller amplitudes other than the greatest (for threshold setting see, for example, U.S. Pat. No. 5,679,953 (Ananth et al.), issued in 1997). The appearance of the electric pulse generated from the photo-detector is the symbol that the “character” <a> is placed in front of the lens 10

Another way to recognize the “character” is shown in FIG. 11. Now the special pattern 69 must be used to form the conjugated sequence of pulses, so it differs from that used for writing down the information. In this second way of reading, the “character” stored in the photosensitive matter 11 is illuminated from the side of the reference pulse. Femtosecond pulse 59 from laser 58, waveguide 56 and collimator 54 forms the beam illuminating the pattern 69 through the dichroic mirror 51 and quarter-wave plate 49. On its back way the series of decoding pulses passes the quarter-wave plate once more and then reflects from the mirror 51 and through another quarter-wave plate 70, condenser 52 and waveguide 55 comes to the lens 9. Then, it illuminates the series of layers 15 to 17 and small reflected pulses form the great one as a result of summation or interference similarly to the previous case On returning back through the same optical system, the circular polarized light becomes plane-polarized and passes through dichroic mirror 51 and lens 167 onto the photo-detector 166 whose threshold is controlled with electronic system 168.

Both of the two reading systems described are able to recognize only one “character”. There must be a set of similar reading and recognizing devices working in parallel or the system to switch the patterns one after another to recognize different “characters” of the set. To accomplish it, any of those devices must be provided with the combination identical to the set of patterns 50 (ROM), quarter-wave plate 49 and the set of optical keys 48 used for writing down the information and controlled with the electronic system capable to the sequential switching of channels to identify which “character” is treated at the moment. This combination 48, 49, 50 is to be placed instead of that one 49, 162 in FIG. 10 or 49, 69 in FIG. 11.

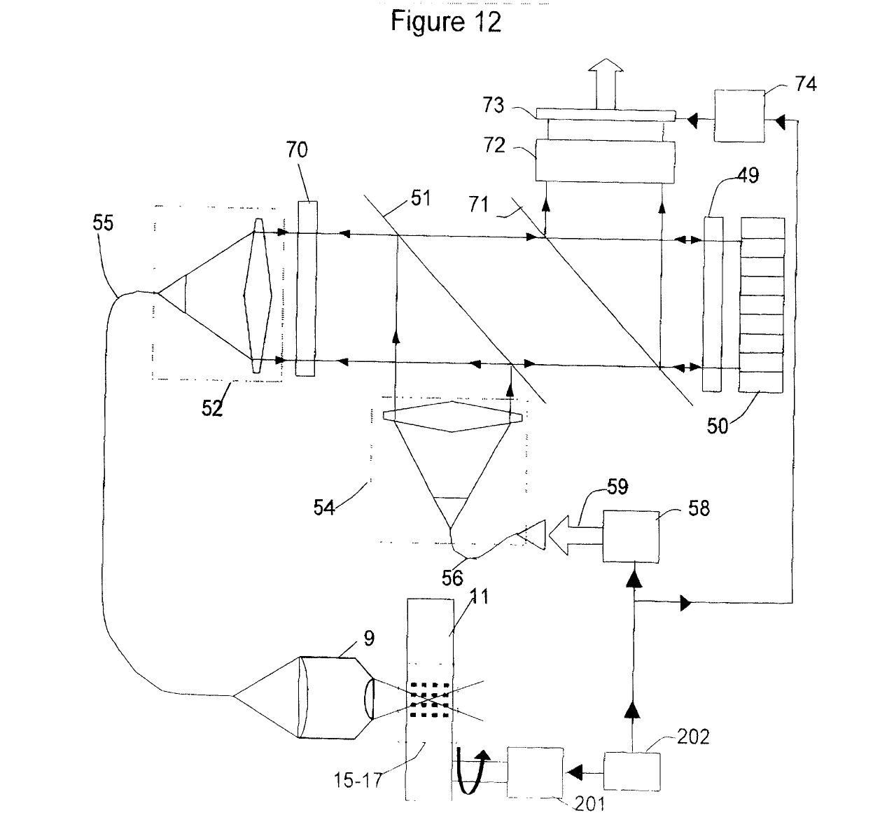

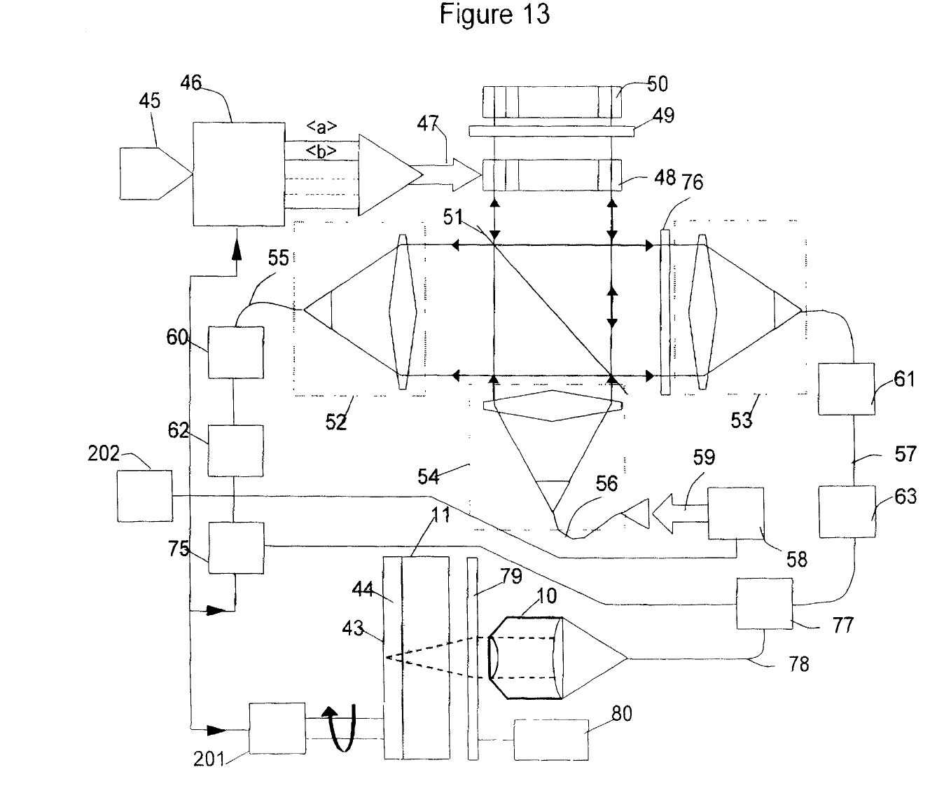

Better results can be achieved with a multichannel system as the one presented in FIG. 12. The plane-polarized femtosecond pulse 59 from laser 58 with the optical channel 56, 54 illuminates dichroic mirror 51 and after reflection comes through quarter-wave plate 70, condenser 52 and waveguide 55 (that may optionally contain the delay line and attenuator) to lens 9 that focuses it into the photosensitive medium 11. Light scattered from layers 15 to 17 backwards passes the same optical way and with the help of quarter-wave plate 70 is converted into the series of plane-polarized pulses conjugated to the written series. On passing through two dichroic mirrors 51, 71 this series illuminates the combination identical to that used in the writing process consisting of a set of the same combination of patterns 50 and quarter-wave plate 49 that was used for writing down. Only one of the channels of set 50 is capable to reflect a series of pulses as a great single pulse. With optical system 72 the image of the set of reflecting patterns is formed onto a multi-element position-sensitive photo-detector 73 (CCD-matrix, for example) whose sensitivity and threshold are controlled by electronic device 74 Coordinates of the spot of maximum brightness are the code for the “character”. Multiple channels working in parallel render this system much faster and more reliable in the recognition of the “character”.

The beam passing through the dichroic mirror 51 may be used for the synchronization of the system operation.

Another combinations of optical elements can be proposed for the reading, all consisting of the same components and operate in the same way as described.

Note that all the systems depicted in FIGS. 9, 10, 11, 12 include only binary splitting of the beams, that makes it easier to appreciate the present invention. It is obvious, for a person skilled in the art to replace these binary splitters with integrated optical elements. Note also that alternative scheme of using sequences of orthogonal polarizations of the beams (either plane or circular) can be used.

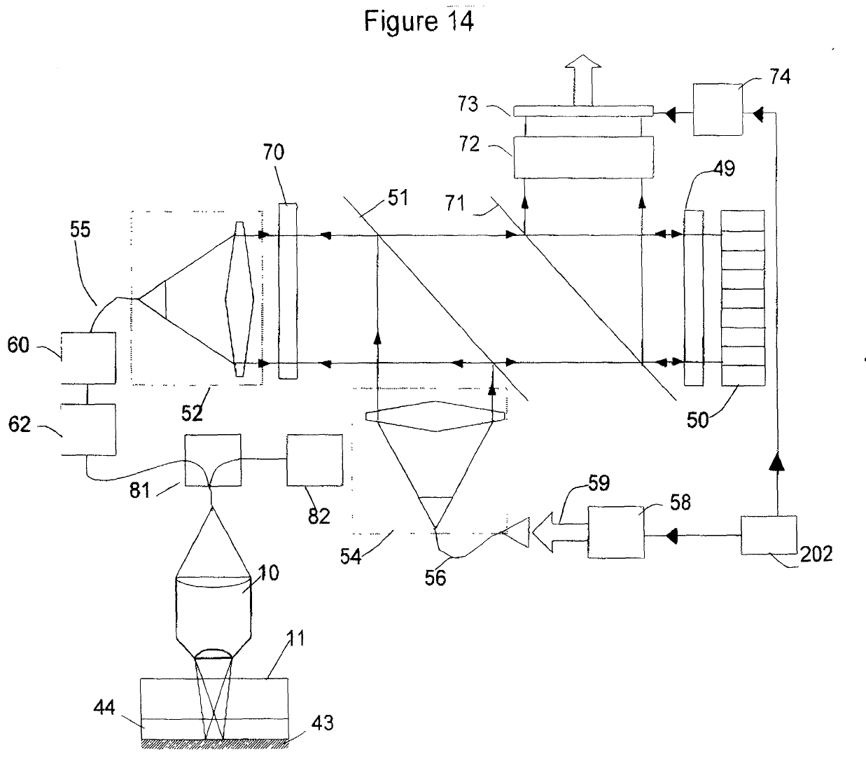

Using a reflection layer deposited onto the photosensitive medium is shown in FIGS. 13, 14. First consider the unit for writing the information. At least three schemes based on different sequences of the state of polarization of ligh in the optical ways can be used, one of them is shown in FIG. 13 It consists of the same main components that are presented in FIG. 9, a plane-polarized two beams coupler is added, a Wallastone prism or a planar waveguide coupler being suitable for this purpose, and an isolator or a fast optical key 75 may be included to prevent pulses from circulating in the system, This key is controlled with the same electronic equipment as keys 48 (not shown in FIG. 13 for simplification). A half-wave plate 76 or similar in its operation device inserted into another branch of the system turns the polarization plane of the “character” 90 in degrees so that it arrives to the coupler 77 with the appropriate orientation of the polarization plane, The rotating CD is to be provided with the quarter-wave layer having the appropriate construction. When a special optical device to compensate for the rotation of optical axes of the quarter-wave layer is used the CD may comprise the optical active layer 44 of a single-directed orientation. The plane of polarization of the illuminating beam to follow synchronously the orientation of the CD, a special rotator of the polarization planes 79 is shown together with its control device 80 in addition to the information-writing device described previously. Such a rotator can be realized using liquid crystals controlled by an electric field or even a mechanical system and positioned in any section of the optical way from coupler 77 to layer 11, preferably between coupler and lens. All other parts of the system operate similarly to those shown in FIG. 9.

To retrieve the information stored in the CD using the most effective parallel reading, the system depicted in FIG. 14 can be used. It differs from that shown in FIG. 12 only in the circularly polarized beams coupler/devider 81 whose only purpose is to join and separate circularly polarized beams This may be a Fresnell prism. One of the beams coming from this prism may be either absorbed with gap 82 or used for the system operation synchronization.

Now follow the operation of the system. The pulsed beam 59 emitted by laser 58 comes to fiber 56 and collimator 54. Supposedly being plane-polarized, this pulse reflects from the dichroic mirror 51, converts to a circularly polarized beam by quarter-wave plate 70 and is compressed with 52 in size to enter into waveguide 55. Attenuator 60 and delay line 62 may be the part of pulse transportation system that delivers it to the coupler 81. The circularly polarized beam of light illuminates the set of slightly reflecting layers that are the “character” stored in medium 11 The set of pulses reflected from these layers are of the same state of polarization as that of the initial beam coming from 81. Great amplitude pulse reflected from the mirror 43 passes the quarter-lambda layer 44 twice and changes its polarization to the opposite On its way back, it is declined by prism 81 and is absorbed or used for another purposes by 82. The rotation polarizer 79, 80 is not shown in the figure for simplification.

On coming back through the chain 81-62-60-55-52-70 the circularly polarized beam consisting of a series of pulses is transformed to plane-polarized beam whose plane orientation is orthogonal to the initial one, that permits the beam to pass through mirror 51 and auxiliary dichroic mirror 71, to reach the decoder 50 consisting of the primary set of patterns The entrance surface of the decoder is imaged with optical system 72 to the multi-element position-sensitive photo-detector 73. Only one of elements of 50 reflects the single pulse of rather great amplitude that forms a bright spot on the receiver 73. The threshold of the receiver and its operation are controlled by electronic device 74. The coordinates of the bright spot are the code of the “character”

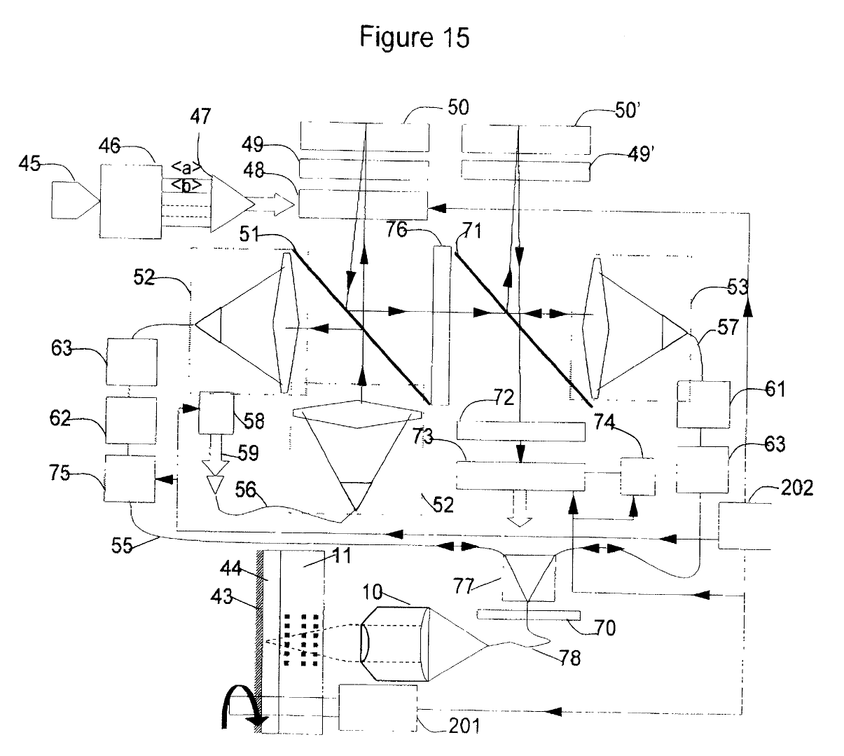

The similarity of the optical schemes shown in FIGS. 13, 14 makes it possible to combine writing and reading systems into one device with simple switching from one mode to another. A preferred embodiment of a combined system in accordance with the present invention is shown in FIG. 15. A pulse of light 59 emitted by femtosecond laser 58 comes to the collimator 54 through waveguide 56. The expanded beam of non-polarized or circularly polarized light is divided into two plane-polarized beams by the beam-splitter (dichroic mirror, in particular) 51. The reference beam passing through the condenser 52, waveguide 55, delay line 60, attenuator 62 and fast optical key 75 is directed to the coupler 77. The other portion of the primary beam illuminates encoding system 49, 50 through the array of optical keys 48. This beam possesses the same orientation of the polarization plane as the reference one, so it is reflected from mirror 51. On its further way to condenser 53 it passes through the half-wave plate 76 and auxiliary dichroic mirror 71 oriented in the same way as 51, so that light comes through it. Then through waveguide 57 it comes to the beam coupler 77, its polarization plane orthogonal to the reference beam. Delay line 61 and attenuator 63 may optionally be installed on its way.

The coupler 77 joins two beams in one set of pulses having the appropriate delay time between them. Afterwards, the pulses get to the quarter-wave plate and become circularly polarized in opposite directions depending on their origin. For writing the information, the interference of the circularly polarized light is used instead of the system depicted in FIG. 13.

To read the information recorded simple switching of the optical components is used; combination of encoding patterns 50 and quarter-wave plate 49 change its position to that marked as 50′ and 49′ to form the decoding device. Additional combination of devices 50 and 49 can also be used for this purpose The process of reading the information is not more complicated then that described in FIG. 14. The pulse 59 from femtosecond laser 58 comes through the chain 54-56-51-52-55-60-62-75-55 to the plane-polarized waves coupler 77. On the exit of the coupler the quarter-wave plate 70 transforms this pulse to circular-polarization. The set of reflected circular-polarized pulses comes to the coupler through the same quarter-wave plate becoming orthogonally polarized with respect to the primary beam, which is directed to the second optical branch of the system. The initial pulse reflected from the mirror 43 on its way crosses twice two quarter-wave layers and as a result gets the previous orientation of the polarization plane, so it goes to the waveguide 55 and is stopped by the key 75.

The recognition of the “character” is realized with the same scheme as in FIG. 14. Synchronization of the operation of all devices is effectuated by special system 202.

In comparison to prior-art methods, the present invention makes it possible: to achieve the optimum between the amount of stored information and accessing and retrieval time; to achieve the greatest possible rate of reading information, the physical limit for the method to read out being the velocity of light in the matter used to store the information and to transfer it from one component to another, to provide a rather simple means for fast and reliable reading of great portions of information (the so-called “characters”) stored in the matter; to achieve the maximum possible rate of writing information in the medium.

To achieve these properties, the method of the present invention uses the effect of interference or time and space coincidence of two counter-propagating ultrashort pulses producing summation of amplitudes or energies of two pulses instead of summation of energy of multiple pulses. It uses effectively and economically the whole space of matter in the vicinity of the focal waist of the focused beam of light instead of localization of a solitary focus to write down a single bit The method of the present invention makes it possible to write down a set of bits in one shot of pulse without re-tuning of the optical elements of the system, that increases the rate of information storage at least by one order of magnitude in comparison to existing methods. The same gain is achieved in the process of information retrieval that results in two orders of magnitude gain in the combination of reading/writing of information.

The system for reading of the invention brings about a highly-reliable way to read information stored in devices similar to existing CDROMs and DVOROMs, and it is compatible with mechanical means of conventional computers.

In the embodiments described in this specification and accompanying Figures the translated information flow which is realized in the form of packets of femtosecond pulses is constructed using an array of keys, which is controlled by a control signal generated from connection circuit 47 (see FIG. 9 for example). It may be possible in the near future to use the control signal to control an array of semiconductor femtosecond lasers to accomplish the task performed by the array of keys and any person skilled in the art will appreciate that once semiconductor femtosecond lasers are made available.

It should be clear that the description of the embodiments and attached Figures set forth in this specification serves only for a better understanding of the invention, without limiting its scope as covered by the following Claims.

It should also be clear that a person skilled in the art, after reading the present specification could make adjustments or amendments to the attached Figures and above described embodiments that would still be covered by the following Claims.

1. An apparatus for writing optical information, consisting of a stream of at least one of a plurality of characters, in photosensitive transparent medium, comprising:
illuminating means for generating a first light beam for carrying encoded optical patterns and a second light beam for serving as a reference beam;
optical encoding means for encoding the first light beam so as to carry optical signal comprising patterns corresponding to said stream of at least one of a plurality of characters and for encoding the second light beam so as to carry a reference optical signal, and
directing means for directing said first beam and second beam substantially in counter-propagating directions and focusing them at a predetermined location within the medium so as to form a focal waist within said medium enabling interference between the two beams at a predetermined location within the medium,
whereby the first encoded light beam and the second reference beam meet within the medium producing a distinct interference pattern corresponding to said at least one of a plurality of characters and locally changing at least one of the optical characteristics of the medium at that location thus causing distinct inhomogeneities in the medium.

2. The apparatus as claimed in claim 1, wherein said illuminating means comprises white light source.

3. The apparatus as claimed in claim 2, wherein said illuminating means comprises light source selected from a lamp, white-light photodiode, a set of colored photodiodes combined to emit white light or a white laser.

4. The apparatus as claimed in claim 1, wherein said illuminating means comprises femtosecond pulse laser.

5. The apparatus as claimed in claim 1, wherein said first and second light beams are spatially and time coherent.

6. The apparatus as claimed in claim 1, wherein said illuminating means produce light whose spectrum is sufficiently broad to create distinctive pikes of an interference pattern in the vicinity of zero-path difference between the two beams.

7. The apparatus as claimed in claim 1, wherein the illuminating means comprise a single light source adapted to generate a single light beam and a beam splitter for splitting the beam into a first and a second beam.

8. The apparatus as claimed in claim 1, wherein said optical encoding means comprise a spatial modulator array comprising an array of optical keys each adapted to be switched between closed and open positions thus either allowing or preventing passage of light through it, and a transformer array comprising an array of optical units each optical unit adapted to reflect incidental pulse in the form of a series of pulses forming an encoded beam corresponding to said at least one of a plurality of characters, wherein the spatial modulator array and the transformer array overlap in such a manner that each optical key of the spatial modulator array corresponds to a single optical unit of the transformer array.

9. The apparatus as claimed in claim 8, wherein the illuminating means comprises a femtosecond laser source and synchronizing means for synchronizing the generation of the first light beam with the operation of the spatial modulator array, so that the generation of a femtosecond pulse coincides with the actuation of the spatial modulator array.

10. The apparatus as claimed in claim 1, wherein said apparatus includes a writing head comprising a first and a second high-quality high numerical aperture lenses, arranged in such a way that the first lens' forward focal point coincides with the second lens' forward focal point in a predetermined position so as to allow recording of the encoded beam in a predetermined portion of the medium; and diverting means for optically diverting the encoded first light beam to the first lens of the writing head and for optically diverting the second reference beam to the second lens of the writing head.

11. The apparatus as claimed in claim 1, wherein said apparatus includes adjusting means for adjusting the timing and amplitude of the series of pulses of the encoded beam and the reference beam.

12. The apparatus of claim 1 wherein said illuminating means generate light beams of sufficient power to locally change at least one of the optical characteristics of a medium selected from photoemulsion, porous glass containing photosensitive matter, conventional optical glass or silica.

13. The apparatus as claimed in claim 1 further comprising shifting means for shifting the medium so as to allow writing optical information in different locations within the medium.

14. The apparatus as claimed in claim 1, wherein the directing means comprise inter alia dichroic mirror so as to allow a polarized portion of the first light beam to pass while reflecting the rest

15. The apparatus as claimed in claim 15, wherein a quarter-wave plate or film is provided to transform plane-polarized light to circularly-polarized and vice versa.

16. The apparatus as claimed in claim 1, wherein it also includes attenuators and optical delay lines for tuning the system, and collimators and condensers.

17. An apparatus for reading information stored in a photosensitive transparent medium in a form of a stack consisting of at least one of a plurality of layers of optical properties inhomogeneities of the medium corresponding to at least one of a plurality of characters comprising:
illuminating means for generating a first reference light beam directed at the stack in the medium;
receiving means for receiving light reflected from the stack;
decoding means for decoding the reflected light by comparing the reflected light with at least one of a plurality of optical patterns corresponding to a plurality of characters so as to recognize said at least one of a plurality of characters.

18. The apparatus as claimed in claim 17 wherein said illuminating means comprises a femtosecond pulse generator for generating a beam of femtosecond pulses, a beam splitter for splitting the laser beam into a first and a second beam the second beam being a source for auxiliary synchronous signals.

19. The apparatus as claimed in claim 18, wherein the receiving means comprises a reading optical head comprising a high-quality high numerical aperture lens, arranged in a way that the lens' forward focal point is in a predetermined position so as to allow illuminating the plurality of layers of optical properties inhomogeneities in a predetermined portion of the medium.

20. A method for providing optical information storage in photosensitive transparent medium, comprising the steps of:
providing illuminating means for generating a first light beam for carrying encoded optical patterns and a second light beam for serving as a reference beam.
providing optical encoding means for encoding the first light beam so as to carry a sequential pack of ultrashort pulses corresponding to said stream of at least one of a plurality of characters and for encoding the second light beam so as to carry a reference optical signal;
providing directing means for directing said first beam and second beam substantially in counter-propagating directions and focusing them at a predetermined location within the medium so as to form a focal waist within said medium enabling interference between the two beams at a predetermined location within the medium;
encoding a flow of information to a sequential pack of ultrashort pulses
focusing said sequential packs of ultrashort pulses and aiming said sequential pack of ultrashort pulses at a predetermined location within the medium;
focusing the reference beam and directing the reference beam opposite to the propagation of said sequential stream of ultrashort light pulses so as to allow their meeting at the predetermined location within the medium causing interference pattern to be formed within the medium at that location causing the formation of optical inhomogeneities within the medium.

21. The method as claimed in claim 20, wherein said illuminating means comprises white light source.

22. The method as claimed in claim 20, wherein said illuminating means comprises light source selected from a lamp, white-light photodiode, a set of colored photodiodes combined to emit white light or a white laser.

23. The method as claimed in claim 20, wherein said illuminating means comprises femtosecond pulse laser.

24. The method as claimed in claim 20, wherein said first and second light beams are spatially and time coherent.

25. The method as claimed in claim 20, wherein the illuminating means comprise a single light source adapted to generate a single light beam and a beam splitter for splitting the beam into a first and a second beam.

26. The method as claimed in claim 20, wherein said optical encoding means comprises a spatial modulator array comprising an array of optical keys each adapted to be switched between closed and open positions thus either allowing or preventing passage of light through it, and a transformer array comprising an array of optical units each optical unit adapted to reflect incidental pulse in the form of a series of pulses forming an encoded beam corresponding to said at least one of a plurality of characters, wherein the spatial modulator array and the transformer array overlap in such a manner that each optical key of the spatial modulator array corresponds to a single optical unit of the transformer array.

27. The method as claimed in claim 26, wherein the illuminating means comprises a femtosecond laser source and synchronizing means for synchronizing the generation of the first light beam with the operation of the spatial modulator array, so that the generation of a femtosecond pulse coincides with the actuation of the spatial modulator array.

28. The method as claimed in claim 20 further comprising providing shifting means and shifting the medium so as to allow writing optical information in different locations within the medium.

29. A method for the optical reading information stored in photosensitive medium using the method of claim 20, comprising the steps of
providing illuminating means for generating a first reference light beam directed at the stack in the medium;
providing receiving means for receiving light reflected from the stack,
providing decoding means for decoding the reflected light by comparing the reflected light with at least one of a plurality of optical patterns corresponding to a plurality of characters so as to recognize said at least one of a plurality of characters;
directing said reference beam and focusing it onto the location within the medium where the information was previously inscribed;
directing the reflected light from the medium via a waveguide to the decoding means to determine the information.

30. The method as claimed in claim 29 wherein the decoding means comprises an array of optical units each optical unit adapted to reflect incidental pulse in the form of a series of pulses forming an encoded beam corresponding to said at least one of a plurality of characters.

31. The method as claimed in claim 29 wherein the illuminating means comprise a femtosecond laser.

32. The method as claimed in claim 29 wherein the medium is provided with a quarter-wave layer or film.
